(19) United States
(12) Patent Application Publication
(10) Pub. No.: US 2008/0236766 A1
(43) Pub. Date: Oct. 2, 2008

(54) WINDOW COVERING

(76) Inventors: Jason Vandervoort, Troy, NY (US); Scott Pauley, Voorheesville, NY (US); Don Nicoll, Clifton Park, NY (US); Thomas J. Marusak, Loudonville, NY (US); John A. Corey, Melrose, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/693,425

(22) Filed: Mar. 29, 2007

(51) Int. Cl. E06B 9/262

(52) U.S. Cl. 160/172 V

(57) ABSTRACT

In a window treatment having vertical blind elements individually suspended from associated hanger elements, each of the vertical blind elements being connected by a connecting panel, an improved hanger is disclosed. The improved hanger includes a hanger body and a bonding portion located near a lower portion of the hanger body. The bonding portion is configured to receive the vertical blind element. Also included is an aperture for hanging the window treatment, the aperture being located near an upper portion of the hanger body, the aperture being spaced at a position substantially at a center of gravity of the vertical blind element with the connecting panel.

### TECHNICAL FIELD

The present disclosure relates generally to window coverings, and more particularly, to multi-panel window coverings.

### BACKGROUND

Window coverings are typically used within windows to block light, allow light, or to provide privacy to a room of a dwelling. The coverings may be drapes, curtains, blinds, or panels, etc. In the case of a vertical paneled window covering, there may be narrow vertical panels that are pivotally mounted to a head rail. When a user desires to have outside light enter a room, the vertical panels are rotated to allow the light through. Otherwise, the vertical panels may be rotated to overlap to block light entry. These vertical panels may be made of fabric, plastic, metal, or wood, among other materials. However, knitted fabrics provide some aesthetic advantages and also allow for panels that have opaque sections as well as translucent sections that connect the panels.

Knitted fabrics are made on a machine that produces variable pitch in the loops and catches that may be called “stitches” in a knit. This may depend in part on the variations in the yarn paths that produce the patterns typical of knits, and in particular, knit laces. The pitch is affected by yarn type, yarn size, tension, lubrication, and finishing. One finishing technique is often referred to as “blocking.” When a knit fabric is blocked, predetermined dimensions are given to a fabric after the knitting operation, but before finishing. In general, blocking is a general term that can be used by numerous methods to expand or contract the size of the knit or material, as well as provide a function of normalizing the size due to variations in manufacturing. Thus, the blocking techniques may be used to change the size or dimensions of the knitted textile after the knitting operation is complete. In addition to dimensional changes, blocking may also be used to clean up the edges of knitted fabrics to provide a crisp, finished edge.

Typically, blocking machines are used to take knitted textiles and by applying heat, steam, or other methods, the knit is formed to a particular size and density, as is desired for window treatments. However, blocking is a highly variable process such that the finished knit is blocked to a size having a significant variation from each blocking, and in particular, from run to run. Knitted and blocked fabrics, and in particular knit laces, have variable pitch in the loops and catches of the knit. The variation in pitch leads to an inconsistent dimensional pattern that is not tolerated for manufacturing of window treatments, especially those with registered, periodic patterns. Thus, while the knitted fabrics are desirable for use with drapery panels, the difficulty and expense of manufacturing has prevented their consistent use.

Despite prior efforts to provide hanging systems for knit drapery panels, these systems exhibit shortcomings. For example, the prior efforts require that uniform periodicity exist in the knit fabric panels. This is because hangers must be attached to each of the hinged panels and must be located precisely with respect to the supported panel so that all panels hang evenly and cooperate together in producing the light-control function of the completed window covering. However, the knit fabrics do not exhibit consistent tolerances for dimensions and periodicity.

Thus, a need exists for improved knit drapery panel elements and methods of making them. Such an improved knit drapery panel would allow for simplified manufacturing of drapery panels having variations in periodicity of the panels. Moreover, the improved knit drapery panel would also allow for variation in the widths of the opaque sections and translucent sections.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of a multi-panel window covering.

FIG. 2 is a perspective view of a generic hanger for use with the window covering of FIG. 1.

FIG. 3A is a perspective view of a right hand hanger for use with the window covering of FIG. 1.

FIG. 3B is a perspective view of a left hand hanger for use with the window covering of FIG. 1, as well as the hanger of FIG. 3A.

FIG. 4 is a perspective view of each generic hanger before assembly into the window covering of FIG. 1.

FIG. 5 is a perspective view showing the hangers of FIG. 4 heat welded to the window covering material.

FIG. 6 is a front view of a heat welding pattern of the hanger of FIG. 3B to the window covering material of FIG. 1.

FIG. 7 is a perspective view of a manufacturing apparatus for the window covering of FIG. 1.

FIG. 8 is a method for aligning and affixing the hangers of FIG. 2, 4A or 4B to the window covering of FIG. 1.

FIG. 9 is a perspective view of an alignment end of the table of FIG. 7 where fixtures and hangers are adjusted to the panel portions.

FIG. 10 is a perspective view of an alignment end of the table of FIG. 7 where hangers are aligned with the window covering and shims are engaged.

FIG. 11 is a side view of a melting arm before heat welding hangers to the window covering material.

FIG. 12A is a perspective view of a right hand hanger for use with the window covering of FIG. 1.

FIG. 12B is a perspective view of a left hand hanger for use with the window covering of FIG. 1, as well as the hanger of FIG. 12A.

FIG. 13A is a perspective view of a stiffener for use with the window covering of FIG. 1.

FIG. 13B is a partial top view of a stiffener for use with the window covering of FIG. 1.

FIG. 14 is a side view of a stiffener installed in a panel of the window covering of FIG. 1.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

The embodiments disclosed herein generally concern multi-panel window coverings. The window covering is a single piece of textile material, e.g. a single drapery panel, which acts as a multi-panel light control system. To achieve the multi-panel effect, the textile material has periodically spaced relatively opaque or translucent sections that define the panels, or sections. Hanger elements are attached directly to panel sections that correlate with the periodic opaque sections. Disclosed herein are methods and apparatuses for attaching hangers to single sheet window covering material. The methods and apparatuses adapt to any non-uniformity of textile material in the spacing of the opaque and translucent panel sections. These variations are typically produced in the manufacture of the textile material. However, the methods and apparatuses described herein compensate for other variations in textile material. In addition to the adaptation to non-uniformity in the textile material, the methods and apparatuses described herein also stabilize the free, cut edge, of the textile material in a similar manner as the attachment of the hangers.

The textile material for a vertical drapery panel typically includes a pattern of a first louver portion connected to a second louver portion by a hinge forming a double-thickness vertical panel, also known as a louver. The vertical panels are typically substantially opaque or translucent depending upon the design or requirements of a user. Multiple vertical panels are connected by sheer panels forming the window covering. When the window covering is in an open position, a user may see through the window covering because the vertical panels are rotated to expose the view through the sheer connecting panels. When the window covering is in a closed position, the substantially opaque and/or translucent panels overlap one another and hide and/or prevent viewing through the sheer connecting panels, providing for reduced light transmission through the window covering as well as privacy to the user. An example of a textile material suitable for use with the embodiments herein includes a woven fabric that includes alternating opaque and translucent sections as are illustrated in U.S. patent application Ser. No. 10/960,272, filed on Oct. 7, 2004, U.S. patent application Ser. No. 10/960,533, filed on Oct. 7, 2004, U.S. patent application Ser. No. 11/099,921, filed on Apr. 6, 2005, U.S. patent application Ser. No. 11/100,280, filed on Apr. 6, 2005, U.S. patent application Ser. No. 11/345,912, filed on Feb. 2, 2006, each claiming priority to U.S. Provisional Application No. 60/562,333, filed Apr. 14, 2004, the contents of all of which are included by reference herein.

A vertical panel window covering may be made of a single-piece textile knit fabric. The knit fabric has opaque portions that act as light control panels. The opaque portions are connected to each other by translucent sections of knit material, all of the same piece. The opaque portions form light-control louvers, connected by sheer connecting panels. When rotated to an open position, the light-control louvers may allow light through the window covering (through the sheer connecting panels). When rotated to a closed position, light and view through the window covering is substantially reduced or blocked.

Hangers are positioned at the top of each opaque portion of the knit fabric for attachment to rotatable clips of a standard vertical blind top-track system. The hangers are manually aligned with (i.e., located to) each opaque portion of the knit fabric due to inconsistencies of the single-piece textile. Except for at the ends, two panels are folded to face each other to create a double-thickness, light-control vane. The standard top-track system allows for the coordinated rotation of each vane, such that the vanes cooperate in a system to allow an open or closed set of vanes. Moreover, the top-track system allows for the sliding and rotating of the panels. When open, the vanes are substantially perpendicular to the window, allowing light to flow through the window covering at the translucent portions. When closed, the vanes are substantially parallel with the window, and each vane slightly overlaps the two adjacent vanes to block light flow and view through the window covering.

To accomplish alignment of inconsistent locations of translucent or opaque panel sections of knit fabric, hangers are centered at each panel section before being attached. Once the hangers are fixed to the fabric, each two (2) panels are folded together to achieve facing contact and the hangers attach to one another to form a double-thickness light-control vane. To accomplish the alignment, the single-piece textile knit fabric is laid out on a table. The table includes fixtures for holding the hangers, where the fixtures are moveable to align the hangers with the panel sections. Once aligned, the knit fabric is bonded to the hangers. One example of this is heat staking. The hangers must be permanently attached to their respective panels of the knit fabric. Moreover, the hangers must be precisely located with respect to the panel so that all panels in the window treatment system hang evenly and cooperate together when rotated to enable the light-controlling function of the completed window covering.

In general, the single-piece textile knit fabric is a panel of periodic design. The hangers are located in a precise relationship to opaque portions of the single-piece textile knit fabric, and the hangers are permanently affixed to the single-piece textile knit fabric at that location. An aperture on the hanger allows for attachment to rotatable clips of a standard vertical blind top track system.

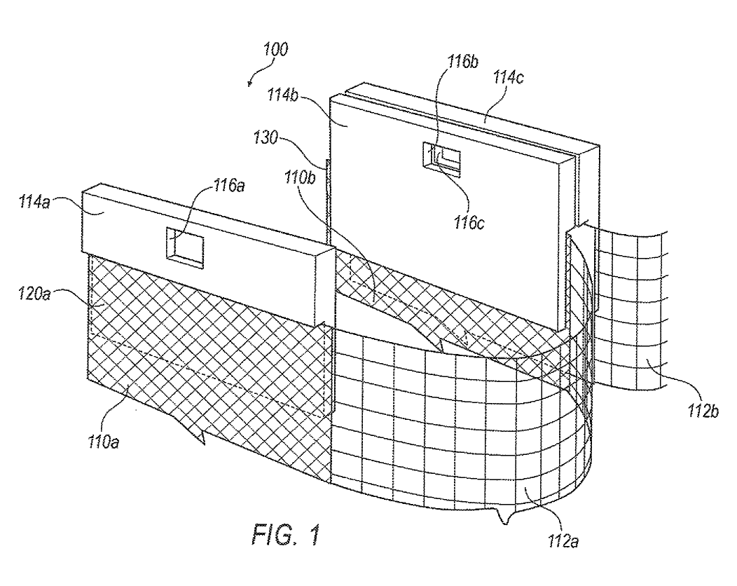

FIG. 1 is a perspective view of a multi-panel window covering 100 that includes vertical panel portions 110a, 110b and sheer connecting panels 112a, 112b. At the top of each vertical panel portion 110a, 110b, a hanger 114a, 114b, 114c is attached. Hangers 114a, 114b, 114c further include an aperture 116a, 116b, 116c for attaching hangers 114a, 114b, 114c and each vertical panel portion 110a, 110b to a standard vertical blind top-track system (not shown). As shown here, multi-panel window covering 100 is in an open position where light is allowed to flow through sheer connecting panels 112a, 112b. The vertical panels are spaced apart and parallel such that light is allowed to flow through sheer connecting panels 112a, 112b and between vertical panel portions 110a, 110b. In a closed position (not shown), each vertical panel portion 110a, 110b is rotated about aperture 116a, 116b, 116c by the standard vertical blind top-track system so that vertical panel portions 110a, 110b overlap each other and block light flow through multi-panel window covering 100.

Sheer connecting panels 112a, 112b are translucent because the knit of the material is not tight and dense. Vertical panel portions 110a, 110b are relatively opaque because they are more tightly knitted and dense. The blocking operation also allows for the adjustability of the density of both sheer connecting panels 112a, 112b and vertical panel portions 110a, 110b. Alternatively, vertical panel portions 110a, 110b may be configured to be more translucent than opaque if the function is merely to control the amount of light through the multi-panel window covering, but not block the light entirely.

Sheer connecting panels 112a, 112b are integral with vertical panel portions 110a, 110b, as they are a part of a single-piece textile knit fabric. However, sheer connecting panels 112a, 112b must also be flexible enough to allow for the rotation of vertical panel portions 110a, 110b with minimal effort. During manufacturing of a single-piece textile knit fabric, sheer connecting panels 112a, 112b are defined from vertical panel portions 110a, 110b by the basic knitting operation. However, the blocking operation is at least partly responsible for creating inconsistency in each single-piece textile knit fabric because the blocking operation may cause variation in the overall size of the single-piece textile knit fabric. Thus, each hanger 114a, 114b, 114c must be aligned with each vertical panel portion 110a, 110b for every single-piece textile knit fabric that is used to manufacture window covering 100.

Hangers 114a, 114b, 114c also include a bonding portion 120a, 120b, 120c that overlaps with the top end of each respective vertical panel portion 110a, 110b. Bonding portion 120A (120B and 120C not shown in FIG. 1) provides a flat surface for the alignment of vertical panel portions 110a, 110b and also provides a surface for the attachment, for example by heat staking or gluing. As shown in FIG. 1, hanger 114a is an end hanger and does not have a paired panel. Hangers 114b and 114c are connected to each other in facing contact and provide a double-thickness panel and that any unfinished edge of vertical panel portion 110b is hidden from a user. The vertical panel portion 110b extends downward and is mated with another vertical panel portion (not shown) to form a double-thickness panel. The double-thickness vertical panel being held together by hangers 114b and 114c and a hinge 130 that connects each vertical panel portion at one end. As discussed herein, hangers 114a, 114b, 114c may include single-part or multiple-part designs and it is understood that the specific embodiments of hangers as discussed herein are not used to limit the scope of this disclosure.

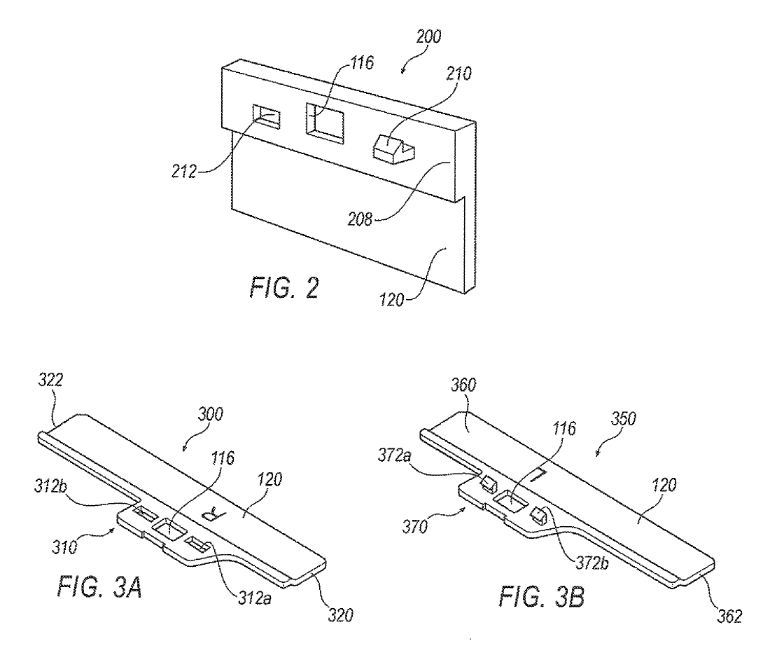

FIG. 2 is a perspective view of a generic hanger 200 for use with the window covering 100 of FIG. 1. Generic hanger 200 is used to hold the top portion of each vertical panel portions 110a, 110b. Generic hanger 200 is typically made of plastic material and includes flat bonding portion 120. As discussed herein, vertical panel portion 110 is permanently attached to hanger 200 at bonding portion 120. A clip 210 is positioned at one side of a facing portion 208. Facing portion 208 is configured as a mating surface for another hanger 200. At the other side, a clip receiver 212 is positioned such that it can receive clip 210 of another generic hanger 200 when they are snapped together. Aperture 116 is positioned between clip 210 and clip receiver 212.

When assembled (as shown in FIG. 1 with respect to hangers 114b and 114c), two generic hangers 200 are pressed together at their respective facing portions 208 and each of their clips 210 engages the other's clip receiver 212. In this way, two generic hangers 200 are mated together. Alternatively, clips 210 and clip receivers 212 may be assisted in holding generic hangers 200 together with glue or heat staking. In another embodiment, clips 210 and clip receivers 212 may not be present and generic hangers 200 are glued or otherwise attached to each other using heat staking.

In addition to holding vertical panel portion 110, aperture 116 allows attachment to a head rail (e.g., a top-track system). The head rail attachment at aperture 116 is typically a non-permanent attachment allowing for replacement or cleaning of the blinds when removed from the window. Moreover, bonding portion 120 provides a stabilizing area for vertical panel portion 110, which may have a cut fabric or knit end. By bonding vertical panel portion 110 at the cut edge onto bonding portion 120, the fabric or knit end is stabilized from fraying or unraveling.

FIG. 3A is a perspective view of a right hand hanger 300 for use with the window covering of FIG. 1. Hanger 300 includes a clip attachment region 310 that includes clip apertures 312a, 312b as well as aperture 116 for attachment to a head rail system. Clip apertures 312a, 312b are configured to receive clips (described in detail below with respect to FIG. 3B). Bonding portion 120 includes a first end 320 and a second end 322. As shown, clip attachment region 310 is biased (spaced) slightly towards first end 320 away from the midpoint between first end 320 and second end 322. The bias of clip attachment region 310, and in particular aperture 116, provides that when hanger 300 is attached to the top rail system, that vertical panel portion 110 is properly balanced to hang vertically. Because window covering 100 is not symmetrical due to sheer connecting panels 112 being at one side, the bias of aperture 116 provides that when hung, vertical panel portion 110 will hang vertically in a balanced maimer. That is to say, the center of gravity of complete window treatment 100 is in line with aperture 116.

FIG. 3B is a perspective view of a left hand hanger 350 for use with the window covering of FIG. 1, as well as hanger 300 of FIG. 3A. Left hand hanger 350 also includes a first end 360 and a second end 362, where a clip attachment region 370 is biased towards first end 360. Clips 372a, 372b extend away from clip attachment region 370 and are configured to mate with clip apertures 312a, 312b to hold left hand hanger 350 and right hand hanger 300 together when they are aligned and pressed together. As with hanger 200 of FIG. 2, hangers 300, 350 of FIGS. 3A and 3B also include bonding regions 120 for permanent attachment of vertical panel portion 10. In addition to the center of gravity balancing provided by the offset to apertures 116, hangers 300, 350 are stylized for improved aesthetics when hung.

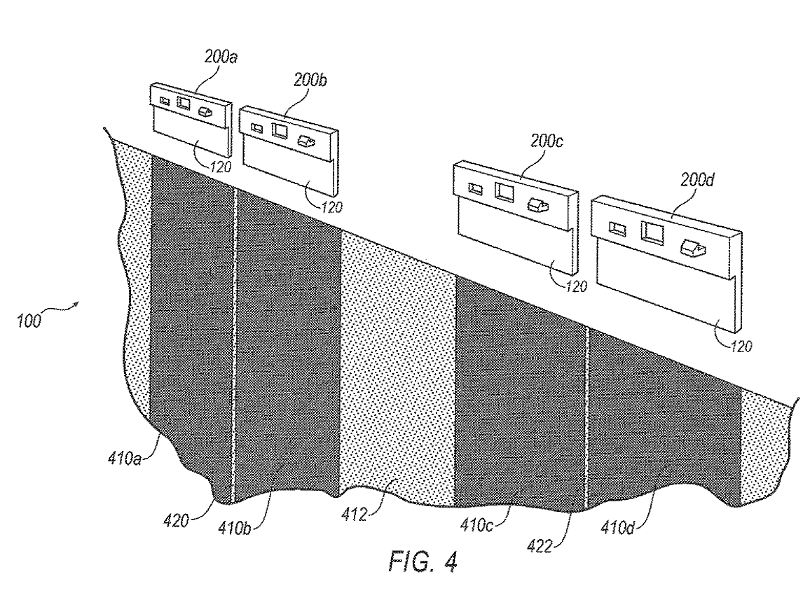

FIG. 4 is a perspective view of each generic hanger 200 before assembly into the window covering 100 of FIG. 1. Each hanger 200a, 200b, 200c, 200d is positioned and in registered orientation with substantially panel portions 410a, 410b 410c 410d, respectively. Moreover, a knitted-in hinge 420 is positioned between the mating hangers 200a, 200b. As shown, a second knitted-in hinge 422 is positioned between mating hangers 200c, 200d. Indeed, when hangers 200 are in proper registration, bonding portion 120 is centered with panel portion 410 and bonding portion 120 does not overlap into knitted-in hinge 420.

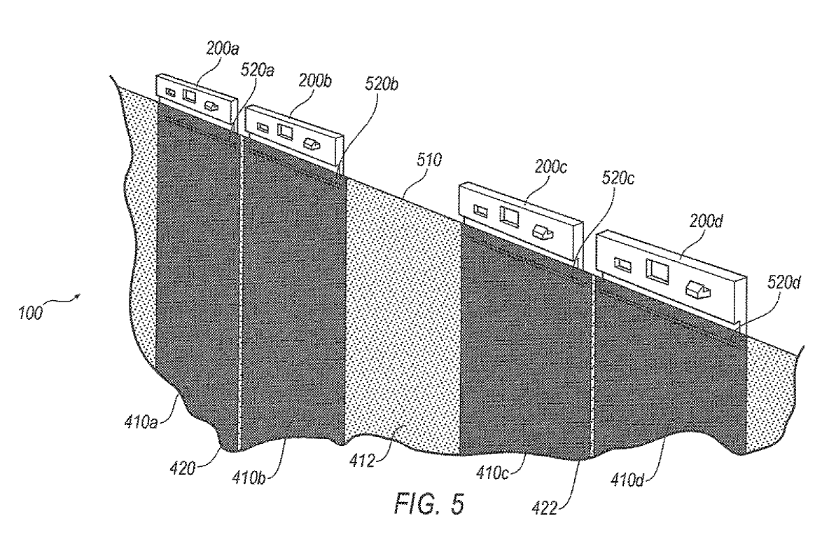

FIG. 5 is a perspective view showing hangers 200 of FIG. 4 heat welded to the window covering 100. After the positioning of hangers 200a, 200b, 200c, 200d relative to panel portions 410a, 410b 410c, 410d, hangers 200a, 200b, 200c, 200d are moved to a position where window covering 100 overlaps bonding portions 120 (shown in FIG. 4). When a cut edge 510 of window covering 100 is aligned with the tops of bonding portions 120, window covering 100 is attached to bonding portions 120. In one embodiment, window covering 100 is heat welded (bonded) with bonding portions 120. Such a heat process may also be called heat staking. Other methods of attachment may be used, such as, but not limited to, gluing, chemical bonding, and mechanical fastening. It is also possible to make removable attachments, for example with hook and loop fasteners. The bonding is shown, in this example, by heat stake lines 520a, 520b, 520c, 520d that signify a permanent attachment of window covering 100 to bonding portions 120.

To facilitate a heat welding process, hangers 200a, 200b, 200c, 200d are made of a thermoplastic material with a melting point of around fifty degrees Fahrenheit (50° F.) below that of the fabric fibers of window covering 100. The melting point of the thermoplastic is below that of the fabric fibers of window covering 100 so that pressing the fibers of window covering 100 causes an impression of the fibers into the softened thermoplastic material of hangers 200a, 200b, 200c, 200d to effect a permanent bond when the thermoplastic material is cooled. Although the melting point is discussed herein as fifty degrees Fahrenheit (50° F.) below the fabric fibers of window covering 100, the melting point may change depending upon the choice of material for window covering 100 and/or hanger 200. Thus, the temperatures provided are a guide.

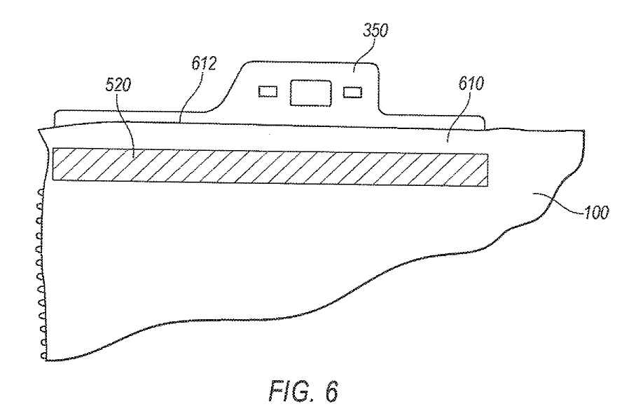

FIG. 6 is a front view of heat welding pattern 520 of the hanger of FIG. 3B to the window covering material of FIG. 1. As shown, heat welding pattern 520 extends the length of hanger 350. Moreover, a top edge 610 is provided as an un-bonded flap of window covering 100. However, in an alternative embodiment, window covering 100 may be bonded all the way to a rough edge 612 to prevent fraying in some cases. Thus, the heat welding process may cover the entire overlapping portion of window covering 100 with hanger 35 0, or any part thereof, of the overlap of window covering 100 and hanger 350. Additionally, the heat welding may not be in the form of a continuous region, but could also be broken into segments or patterns. As discussed above, the heat welding of window covering 100 to hanger 350 is not the only method of bonding.

In addition to bonding window covering 100 with hanger 350, top edge 610 allows an inspector to visually determine whether complete bonding has taken place between window covering 100 with hanger 350, as evidenced by heat welding pattern 520. Moreover, an inspector could test the bond by applying force to top edge 610 (e.g. by tugging or another suitable force). Such a testing method allows for the test of the bond without damaging any of the visible portions of window covering 100.

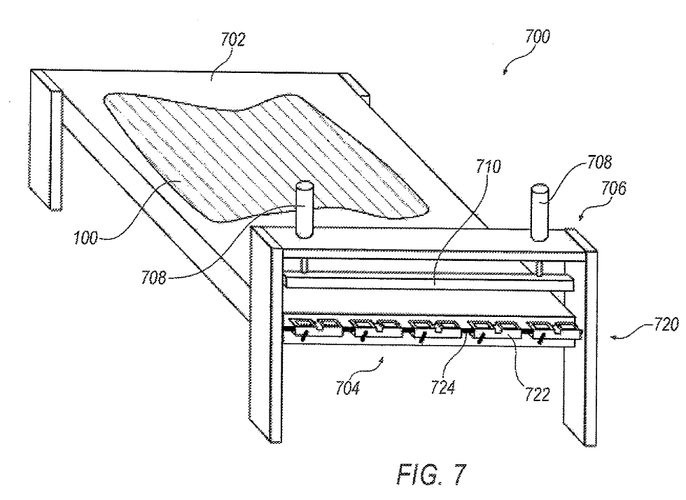

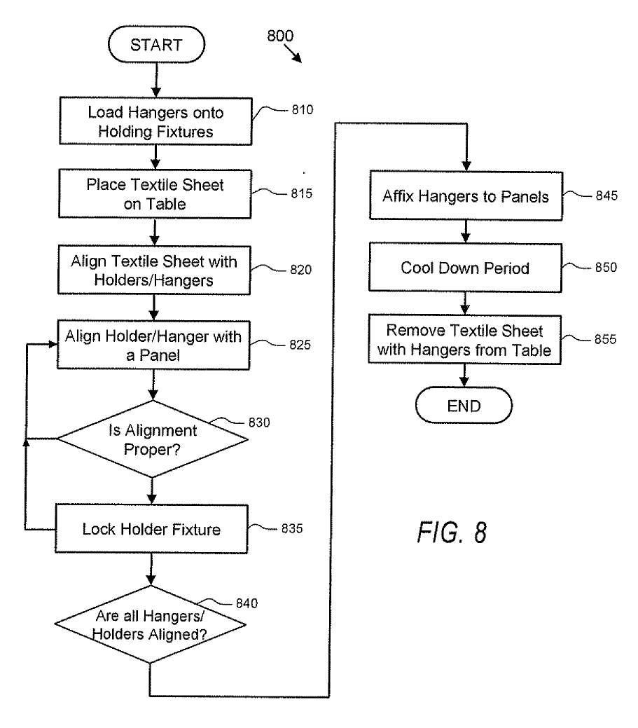

FIG. 7 is a perspective view of a manufacturing apparatus 700 for the window covering 100 of FIG. 1. Manufacturing apparatus 700 includes a table 702 with fixtures 704 to hold and locate hangers 200 at their proper alignment with respect to window covering 100. Additionally, manufacturing apparatus 700 includes a heat bonding fixture 706 that includes cylinder actuators 708, and a heat bar 710. Table 702 is configured to receive window covering 100 in sheet form. A user then loads hangers 200 into fixtures 704 and aligns the fixtures (including hangers 200) with the opaque portions of window covering 100. Fixtures 704 are located at an adjusting end 720 that includes moveable fixtures 722, each configured to securely hold hanger 200, and are movable left or right along a rail 724 to allow for manual alignment of each hanger (when loaded) with each panel. Manufacturing apparatus 700 and the methods of use are described in detail below with respect to FIGS. 8-11.

FIG. 8 is a manufacturing process 800 for aligning and affixing the hangers (shown in FIGS. 2, 3A and 3B) to window covering 100 of FIG. 1. Manufacturing process 800 is used in conjunction with the apparatuses and items described herein. The process begins when a user loads moveable fixtures 722 with hangers 200. The user should inspect each moveable fixture 722 to ensure that hangers 200 are securely held. In general, moveable fixtures 722 may be moved to an approximate location, or if recently used with the same batch of window covering 100, they may be left in the locations from the last use. Where a new batch of window covering 100 is to be used, the user may evenly space moveable fixtures 722. The process then proceeds to step 815.

At step 815, the user loads a sheet of window covering 100 onto table 702. The user may be required to cut the sheet from a bulk source, or the sheets of window covering 100 may be pre-cut to the appropriate size. When the user loads window covering 100 onto table 702, the sheet should be laid flat and any folds or inconsistencies determined by inspection. Control then proceeds to step 820.

At step 820, the user aligns cut edge 510 of window covering 100 with the bonding portion 120 of each hanger 200 (see FIG. 5). The alignment ensures that window covering 100 is properly squared to table 702, movable fixtures 722, and hangers 200 (being held by movable fixtures 722). That is, the edge of the panel is aligned and overlaps bonding portion 120 of hangers 200. Control then proceeds to step 825.

At step 825, the user aligns each movable fixture 722 (including hanger 200) to align the centers of movable fixture 722 with substantially panel portions 410 (see FIG. 4). Moreover, the user inspects the positioning of movable fixture 722 such that hanger 200 does not overlap knitted-in hinge 420, which is to be positioned between hangers 200 (see FIG. 4). Indeed, when movable fixture 722 is in proper registration, bonding portion 120 is centered with panel portion 410 and bonding portion 120 does not overlap into knitted-in hinge 420. Control then proceeds to step 830.

At step 830, the user inspects the alignment of each moveable fixture 722 and hanger 200 with respect to substantially panel portions 410 and knitted-in hinge 420. If each element is not in the proper position, control proceeds to step 825. Otherwise, if the registration of each moveable fixture 722 and hanger 200 is proper, control proceeds to step 835.

At step 835, moveable fixtures 722 are locked into position such that movable fixture 722 and hanger 200 are not inadvertently moved during the rest of the process. Control then proceeds to step 840.

At step 840, a final check of alignment is performed. If alignment is proper, control proceeds to step 845. Otherwise, if alignment is improper, then the offending movable fixtures 722 are unlocked and control proceeds to step 825.

At step 845, heat bar 710 is lowered for attaching window covering 100 to each hanger 200. The time, temperature, and pressure of heat bar are adjusted such that the appropriate melting of hanger 200 is achieved without damaging the knit material of window covering 100. Moreover, the pressure applied by heat bar 710 is adjusted such that sufficient force is applied to push the fibers of window covering 100 into the soft thermoplastic material of hanger 200, but without deforming hanger 200. Control then proceeds to step 850.

At step 850, heat bar 710 is raised away from window covering 100 and a cooling period is performed. Control then proceeds to step 855.

At step 855, the completed window covering 100 is removed from table 702 and each hanger 200 may be mated with its adjacent hanger 200. The process then ends.

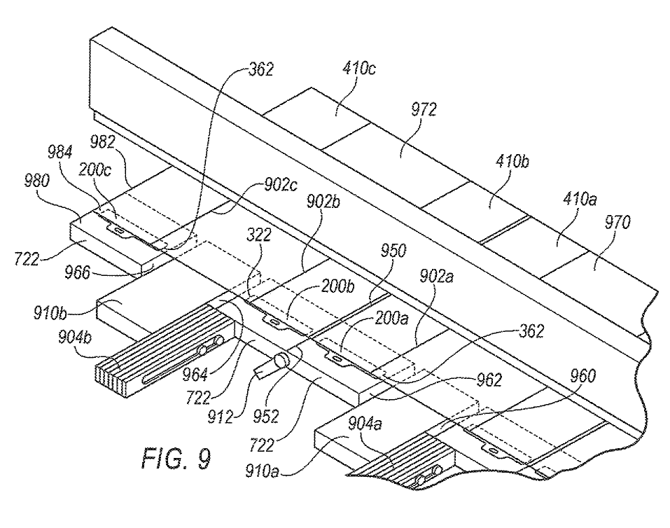

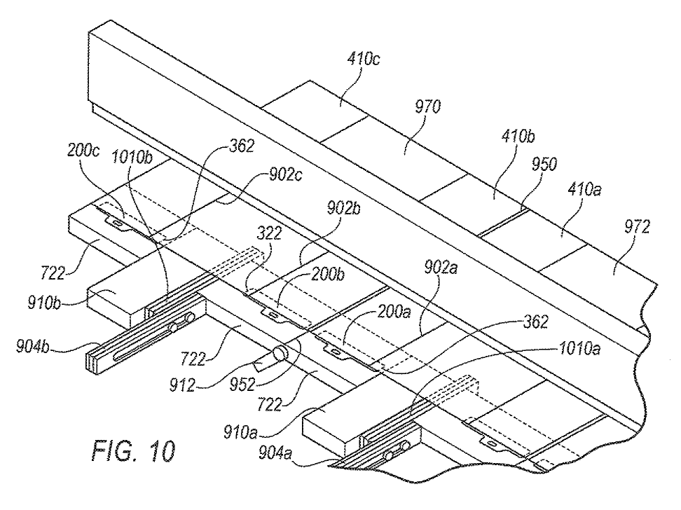

FIG. 9 is a perspective view of an alignment end of table 702 of FIG. 7 where fixtures and hangers 200 are adjusted to align with the panel portions. A scribed line 952 is aligned with the center of a knitted-in hinge 950 (knitted-in hinge also being discussed generally with respect to FIGS. 5 and 6), As shown, fixtures 722 are aligned with panel portions 410a, 410b, 410c. Turning to panel portion 410c, an outer edge 982 of panel portion 410c is aligned with an end 980 of fixture 722. A gap 820 may be present at an end of hanger 200c to allow for adjustment of hanger 200c in relation to the center of gravity of the entire window covering, including sheer sections 970, 972. When performing the alignment of fixtures 722 with panel portions 410, spacer blocks 910a, 910b, and shims 904a, 904b are free to move laterally. When moving spacer blocks 910a, 910b, and shims 904a, 904b, spaces 960, 962, 964, 966 allow fixtures 722 to be moved laterally so that they can be aligned with panel portions 410 and knitted-in hinge 950. As will be shown in FIG. 10, spacer blocks 910a, 910b, and shims 904a, 904b are fixed in place before attachment of panel portions 410 to hangers 200.

As discussed above with respect to FIG. 8, each movable fixture 722 is adjusted such that each hanger 200 is in proper registration with panel portions 410. The registration is preserved by using adjustable shims 904a, 904b that include slender shim portions that slide between movable fixtures 722 and spacer blocks 910a, 910b. To position movable fixtures 722, a locking mechanism 912 is unlocked so that movable fixtures 722, spacer blocks 910a, 910b, and shims 904a, 904b are allowed to be moved laterally (e.g., side to side) by a user. To adjust moveable fixtures 722, portions of adjustable shims 904a, 904b are moved between movable fixtures 722 and spacer blocks 910a, 910b to laterally orient moveable fixtures 722.

FIG. 10 is a perspective view of an alignment end of the table of FIG. 7 where hangers 200 are aligned with the window covering and shims are engaged. Adjustable shims 904a, 904b have been positioned between movable fixtures 722 and spacer blocks 910a, 910b to preserve the alignment of hangers 200a, 200b, 200c with their respective panel portions 410a, 410b, 410c. A number of shims 904a, 904b are pushed toward the table, filling in spaces 962, 964 which in turn moves spacer blocks 910a, 910b up against fixtures 722 (see FIG. 9). The shims 904a, 904b that are moved inwardly are considered engaged shims 1010a, 1010b. When properly adjusted, spaces 960, 962, 964, 966 no longer exist because spacer blocks 910a, 910, and engaged shims 1010a, 1010b, fill the space. Additionally, as shown in FIG. 10 below and discussed in FIG. 8 above, spacer blocks 910a, 910b and engaged shims 1010a, 1010b provide a support surface that sheer sections 970, 972 may be pressed against during the heat fusion or bonding operation.

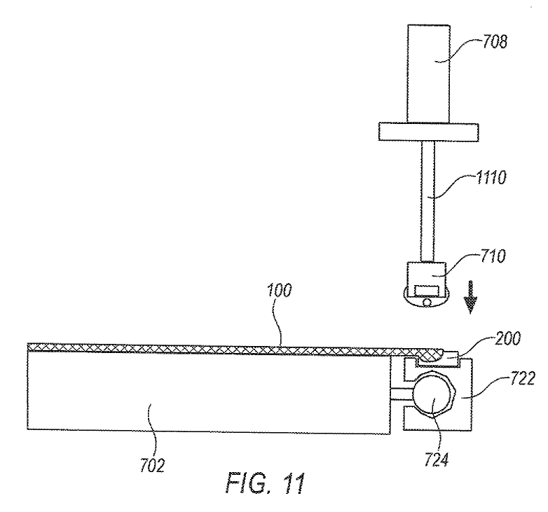

When the final positioning is verified, locking mechanism 912 is rotated to engage locks that hold movable fixtures 722 in place. Locking mechanism 912 prevents movement of moveable fixtures 722 during manufacturing and/or the heat fusion stage. If spaces 960, 962, 964, 966 (or any other gaps) remain open during the heat fusion process (described above in FIG. 8 and below in FIG. 11) then the fabric of window covering 100, including panel portions 410 and sheer sections 970, 972 may burn, melt, deform, or otherwise be damaged. In moving spacer blocks 910a, 910b and engaged shims 1010a, 1010b to entirely fill spaces 960, 962, 964, 966, the heat from heat bar 710 (shown in FIGS. 7 and 11) will transfer through window covering 100 to the metal (or otherwise thermally conductive material) of spacer blocks 910a, 910b and engaged shims 1010a, 1010b, and be carried away. If gaps were present, then window covering 100 would heat up rapidly above the material's specified maximum temperature.

FIG. 11 is a side view of the heat fusion mechanism, including heat bar 710. Table 702 supports window covering 100 for placement relative to movable fixture 722. Rail 724 allows for lateral movement of movable fixtures 722 (shown in FIG. 10). When heat welding of window covering 100 to hanger 200 is performed, cylinder actuator 708 pushes heat bar 710 downwardly with a rod 1110. When heat bar 710 comes into contact with window covering 100 and hanger 200, the heat from heat bar 710 melts the thermoplastic material of hanger 200 and the pressure applied by heat bar 710 pushes the knit material of window covering 100 into the melted thermoplastic for a permanent bond.

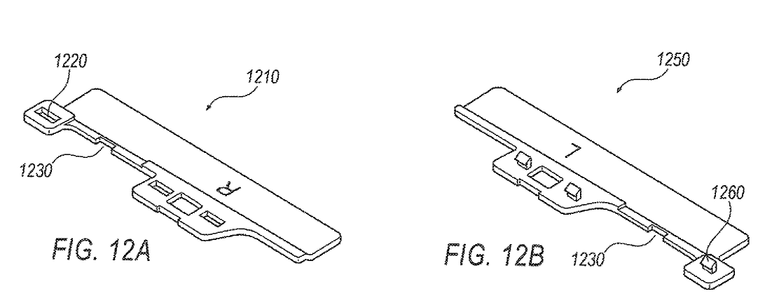

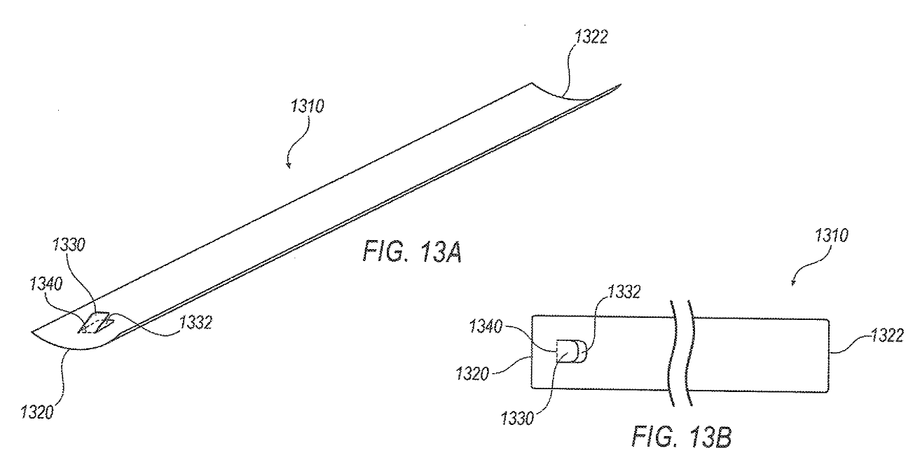

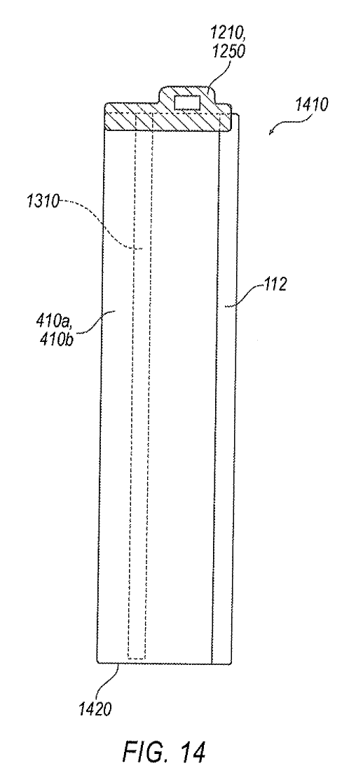

FIG. 12A is a perspective view of an alternative right hand hanger 1210 for use with window covering 100 of FIG. 1. Although similar to hanger 300 of FIG. 3A, hanger 1210 included additional elements, including a snap receptacle 1220 and a stiffener receiver 1230. As will be described below, a stabilizer attaches at stiffener receiver 1230 to provide a consistent drape to window covering 100. Stiffener receiver 1230 is a slot that will accept a stiffener (described below in detail with respect to FIGS. 13A-14). Snap receptacle 1220 is configured to receive a snap described below in detail with respect to FIG. 12B and also provides a rigid end connection for the mating hanger.

FIG. 12B is a perspective view of an alternative left hand hanger 1250 for use with window covering 100 of FIG. 1, as well as hanger 1210 of FIG. 12A. While similar to hanger 350 of FIG. 2B, hanger 1250 also includes stiffener receiver 1230 and a snap 1260. Snap 1260 is configured to mate with snap receptacle 1220 to form a rigid end connection when right hand hanger 1210 and left hand hanger 1250 are mated.

FIG. 13A is a perspective view of a stiffener 1310 for use with window covering 100 of FIG. 1. Stiffener 1310 is configured as a curved piece having a first end 1320 and a second end 1322. Near first end 1320, a latch 1330 is die-cut through stiffener 1310 leaving a hole 1332. When latch 1320 is punched, a hinge portion 1340 allows latch 1330 to fold away from the main surface of stiffener 1310. Also, as shown, stiffener 1310 is formed with a camber or other non-planar configuration to improve resistance to bending. Alternatively, stiffener 1310 may be configured as a tubular form.

FIG. 13B is a partial top view of stiffener 1310 shown in FIG. 13A. As shown, hinge portion 1340 allows latch 1330 to be pushed upwardly leaving hole 1332. Stiffener 1310 is an elongated strip of resilient material, such as rigid polyvinyl chloride (PVC). In one embodiment, stiffener 1310 is optically clear and has a width less than the width of stiffener receiver 1230.

FIG. 14 is a side view of stiffener 1310 installed in a panel 1410 of window covering 100 of FIG. 1. As shown, right hand hanger 1210 and left hand hanger 1250 are mated with panel portions 410a, 410b pressed together. Between panel portions 410a, 410b, stiffener 1310 extends from hangers 1210, 1250 and provides stability to panel portions 410a, 410b. Generally, stiffener 1310 is not as wide as panel 410 so that it is less noticeable and does not extend beyond the sides of panel 410. In an embodiment, stiffener 1310 is less than three and one half inches (3.5″) wide. In an exemplary embodiment, stiffener 1310 is one and one eighth inches (1.125″) where panel portions 410a, 410b are four inches (4″) wide. As sheer connecting panel 112 is located toward a user, the location of stiffener 1310 away from sheer connecting panel 112 allows it to be hidden from view. In an open mode, a user looks directly along the narrow aspect of panel portions 410a, 410b. Thus, a spring pressure of adjacent panel portions 410a, 410b provides that a user does not see between them to stiffener 1310. Moreover, when in a closed mode, stiffener 1310 is hidden from view by an adjacent overlapping panel portion 410.

Stiffener 1310 is assembled by sliding stiffener end 1320, wit latch 1330, upwardly through stiffener receiver 1230. Latch 1330 extends outwardly from the surface of stiffener 1310 via hinge portion 1340. When assembling stiffener 1310 to right band hanger 1210 and left hand hanger 1250, each stiffener receiver 1230 forms a bounded slot that receives stiffener 1310. Because latch 1330 extends via hinge portion 1340, when pushing stiffener 1310 through stiffener receiver 1230, latch 1330 will yield and flex inwardly toward stiffener 1310 until pushed all the way through stiffener receiver 1230. Once latch 1330 is pushed past stiffener receiver 1230, latch 1330 will extend outwardly past stiffener receiver 1230 and will be retained from moving downwardly. Moreover, because latch 1330 is moveable, stiffener 1310 may be removed from hangers 1210, 1250 by pressing latch 1330 inwardly and sliding stiffener 1310 through stiffener receiver 1230.

The curvature of stiffener 1310 provides flexural and torsional stability to panel portions 410a, 410b when turned. Thus, a bottom portion 1420 of panel portions 410a, 410b will turn substantially in unison with hangers 1210, 1250. Otherwise, depending upon the rigidity of panel portions 410a, 410b, bottom portion 1420 may not move in unison or may lag when hangers 1210, 1250 are turned. Additionally, when hangers 1210, 1250 come to rest, bottom portion 1420 may sag or droop and may not be angularly aligned with hangers 1210, 1250.

By providing stiffener 1310, the performance of panel portions 410a, 410b is greatly improved at bottom portion 1420. When a rotational input is provided to panel portions 410a, 410b at hangers 1210, 1250, bottom portion 1420 is impelled to rotate in unison, or substantially in unison, with hangers 1210, 1250. With reference to FIG. 1, when window covering 100 is in a view through-mode, stiffener 1310 maintains the parallelism of each fabric vane (e.g., panel portions 410a, 410b). Moreover, stiffener reduces the tendency of bottom portion 1420 to curl to the side. In privacy mode (e.g., when the fabric vanes are rotated to overlap and prevent light from passing through) stiffeners improve the degree of closure, whereby bottom portion 1420 naturally attempts to remain in a view-through mode, stiffener 1310 urges the rotation of bottom portion 1420 to a closed position. Moreover, stiffener 1310 is inexpensive, light weight, and easily installed and replaced without additional hardware (since latch 1330 is integral with stiffener 1310). When clear material is used for stiffener 1310, it is also invisible to the eye.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. In a window treatment comprising vertical blind elements individually suspended from associated hanger elements, each of said vertical blind elements being connected by a connecting panel, the improved hanger comprising:
a hanger body;
a bonding portion located near a lower portion of said hanger body, wherein said bonding portion is configured to receive said vertical blind element; and
an aperture for hanging said window treatment, said aperture being located near an upper portion of said hanger body, said aperture being spaced at a position substantially at a center of gravity of said vertical blind element with said connecting panel.

2. The window treatment of claim 1, wherein said vertical blind elements comprise a first panel and a second panel, said first and second panels being folded over at a hinge portion positioned therebetween.

3. The window treatment of claim 1, wherein said bonding portion is substantially covered by said first vertical blind element.

4. The window treatment of claim 1, wherein said hanger body is substantially centered with said first vertical blind element.

5. The window treatment of claim 1, wherein said first vertical blind portion is attached to said bonding portion with heat.

6. The window treatment of claim 1, wherein fibers of said vertical blind portion commingle with said bonding portion when said bonding portion is melted and said vertical blind portion is pressed into the melted bonding portion.

7. The window treatment of claim 1, wherein said vertical blind elements have different light transmission characteristics than said connecting panel.

8. The window treatment of claim 1, wherein said vertical blind elements have a different density than said connecting panel.

9. The window treatment of claim 1, wherein said vertical blind elements and said connecting panel are part of a single-piece knit material.

10. The window treatment of claim 1, further comprising:
a stiffener that reduces twist of said vertical blind element.

11. The window treatment of claim 10, wherein said stiffener attaches to said hanger body and extends away from said hanger body along said vertical blind element.

12. The window treatment of claim 10, wherein said stiffener is curved.

13. An apparatus comprising:
a table for receiving a single-piece window covering, said single-piece window covering including a first region and a second region;
at least one moveable fixture configured to receive a hanger, wherein said at least one moveable fixture is positioned to align said hanger with said first region; and
a bonder for attaching said single-piece window covering with said hanger.

14. The apparatus of claim 13, wherein said bonder applies heat and pressure to said single-piece window covering and said hanger.

15. The apparatus of claim 14, wherein said at least one moveable fixture is locatable parallel to an edge of said table.

16. The apparatus of claim 13, wherein said single-piece window covering is a knit material.

17. The apparatus of claim 13, wherein said table and said at least one movable fixture cooperate to align an edge of said single-piece window covering with said hanger.

18. The apparatus of claim 13, wherein said at least one moveable fixture is lockable.

19. A method comprising:
receiving a single-piece window covering having at least one panel portion and a top edge;
locating at least one hanger relative to said at least one panel portion and said top edge; and
bonding said at least one panel portion with said at least one hanger.

20. The method of claim 19, further comprising:
inserting at least one shim adjacent said at least one hanger to position said hanger in the middle of said panel portion along said top edge.

21. The method of claim 19, wherein said locating includes centering said least one hanger central to said panel portion along said top edge.

22. The method of claim 19, farther comprising:
providing a plurality of panel portions and a plurality of hangers.

23. The method of claim 22, said method further comprising:
locating each of said plurality of hangers relative to each of said plurality of panel portions.

24. An apparatus for a window treatment, said window treatment comprising a vertical treatment portion having a top end and a bottom end, said top end being attached to a hanger, said apparatus comprising:
a stiffener configured to attach to said hanger, said stiffener extending at least partially along said vertical treatment portion when attached to said hanger.

25. The apparatus of claim 24, wherein said stiffener comprises an elongated member.

26. The apparatus of claim 25, wherein said stiffener comprises a curved surface.

27. The apparatus of claim 24, wherein said stiffener comprises a latch configured to mate with said hanger.

28. The apparatus of claim 24, wherein said stiffener is a rigid mechanical connection between said top end and said bottom end.

29. An apparatus for a vertical blind element of a window treatment, said vertical blind element comprising a first panel and a second panel, said first and second panels being folded together to form said vertical blind element, said apparatus comprising:
a stiffener located between said first panel and said second panel, said stiffener extending at least partially along said vertical treatment portion.

30. The apparatus of claim 29, further comprising:
a hanger located at a top end of said vertical blind element.

31. The apparatus of claim 30, wherein said stiffener attaches to said hanger.

32. The apparatus of claim 29, further comprising a latch near an end of said stiffener.

33. The apparatus of claim 29, wherein the horizontal width of said stiffener is less than the horizontal width of said vertical blind element.

34. The apparatus of claim 29, wherein the horizontal width of said stiffener is less than three and one half inches.
